(19) United States
(12) Patent Application Publication
(10) Pub. No.: US 2011/0047962 A1
(43) Pub. Date: Mar. 3, 2011

(54) PULSE DETONATION COMBUSTOR CONFIGURATION FOR DEFLAGRATION TO DETONATION TRANSITION ENHANCEMENT

(75) Inventors: Ross Hartley Kenyon, Waterford, NY (US); Adam Rasheed, Glenville, NY (US)

(73) Assignee: GENERAL ELECTRIC COMPANY, SCHENECTADY, NY (US)

(21) Appl. No.: 12/549,943

(22) Filed: Aug. 28, 2009

(51) Int. Cl. F02K 7/02

(52) U.S. Cl. 60/247

(57) ABSTRACT

According to one aspect of the invention, a pulse detonation combustor chamber is provided having an ignition chamber and a detonation chamber. The cross-sectional area of the ignition chamber is greater than the cross-sectional area of the detonation chamber. A flame is generated in the ignition chamber upon ignition of a flammable mixture. The flame flows into the detonation chamber and detonates within the detonation chamber.

### BACKGROUND

In pulse detonation combustors, a mixture of fuel and oxidizer, such as air, is ignited and is transitioned from deflagration to detonation, so as to produce detonation waves, which can be used to provide thrust, among other functions. This deflagration to detonation transition (DDT) typically occurs in a tube or pipe structure, having an open end through which the exhaust exits.

The deflagration to detonation process begins when a fuel-oxidizer mixture in a tube is ignited via a spark or other source. The subsonic flame generated from the spark accelerates as it travels along the length of the tube due to various flow mechanics. As the flame reaches sonic velocity, shocks are formed which reflect and focus creating “hot spots” and localized explosions, eventually transitioning the flame to a supersonic detonation wave.

As indicated previously, the above-described process takes place along the length of a tube, and is often referred to as the run-up to detonation, i.e. the distance/time from spark to detonation.

However, a problem with existing smooth walled tube structures is the relatively long run-up length necessary to achieve detonation of the fuel-air mixture. In fact, in many applications the run-up length, up to detonation, can be such that the ratio L/D (i.e. tube length over tube diameter) is greater than 100. This run-up length is problematic when trying to incorporate the pulse detonation combustor in applications where space and weight are important factors, such as aircraft engines. Efforts have been made to reduce the run-up length to detonation by using obstacles within the flow, in an effort to enhance mixing of the fuel-oxidizer mixture, and typical run-up lengths with obstacles is around L/D of 30. However, there still exists a need to reduce the run-up length and accelerate the development of the flame kernel around the spark or ignition source.

For these and other reasons, there is a need for the present invention.

### SUMMARY

According to one aspect of the invention, a pulse detonation combustor chamber is provided having an ignition chamber and a detonation chamber. The cross-sectional area of the ignition chamber is greater than the cross-sectional area of the detonation chamber. A flame is generated in the ignition chamber upon ignition of a flammable mixture. The flame propagates into the detonation chamber and detonates within the detonation chamber.

### BRIEF DESCRIPTION OF THE DRAWINGS

The nature and various additional features of the invention will appear more fully upon consideration of the illustrative embodiments of the invention which are schematically set forth in the figures. Like reference numerals represent corresponding parts.

FIG. 1 illustrates a cross-sectional view of a pulse detonation combustor according to an exemplary embodiment of the present invention;

FIG. 2 illustrates a cross-sectional view of a pulse detonation combustor according to another exemplary embodiment of the present invention;

FIG. 3 illustrates a cross-sectional view of a pulse detonation combustor according to yet another exemplary embodiment of the present invention;

FIG. 4 illustrates a cross-sectional view of a pulse detonation combustor according to a further exemplary embodiment of the present invention;

FIG. 5 illustrates a pulse detonation combustor according to an alternative exemplary embodiment of the present invention;

FIG. 6 illustrates a pulse detonation combustor according to another exemplary embodiment of the present invention; and

FIG. 7 illustrates a pulse detonation combustor according to a further alternative exemplary embodiment of the present invention.

### DETAILED DESCRIPTION

As used herein, a “pulse detonation combustor” PDC is understood to mean any device or system that produces both a pressure rise and velocity increase from a series of repeated detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs include a means of igniting a fuel/oxidizer mixture, for example a fuel/air mixture, and a detonation chamber, in which pressure wave fronts initiated by the ignition process coalesce to produce a detonation and quasi-detonation. Each detonation or quasi-detonation is initiated either by external ignition, such as spark discharge or laser pulse, or by gas dynamic processes, such as shock focusing, auto ignition or by another detonation (i.e. cross-fire). Pulse detonation may be accomplished in a number of types of detonation chambers including detonation tubes, shock tubes, resonating detonation cavities, for example. In addition, a PDC can include one or more detonation chambers.

Pulse detonation combustors are used for example in aircraft engines, missiles, and rockets. As used herein, “engine” means any device used to generate thrust and/or power. As used herein, “detonation” includes both detonations and quasi-detonations.

Embodiments of the present invention will be explained in further detail by making reference to the accompanying drawings, which do not limit the scope of the invention in any way.

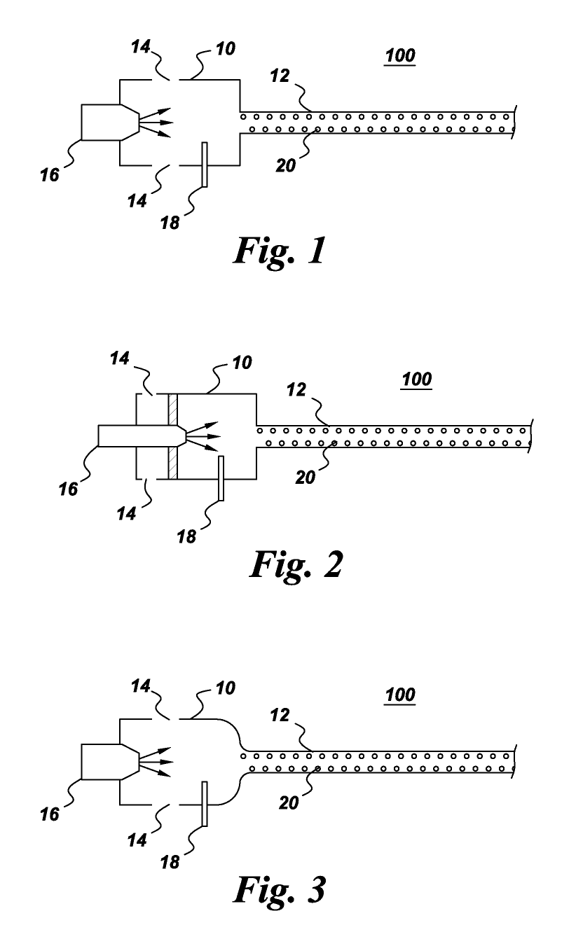

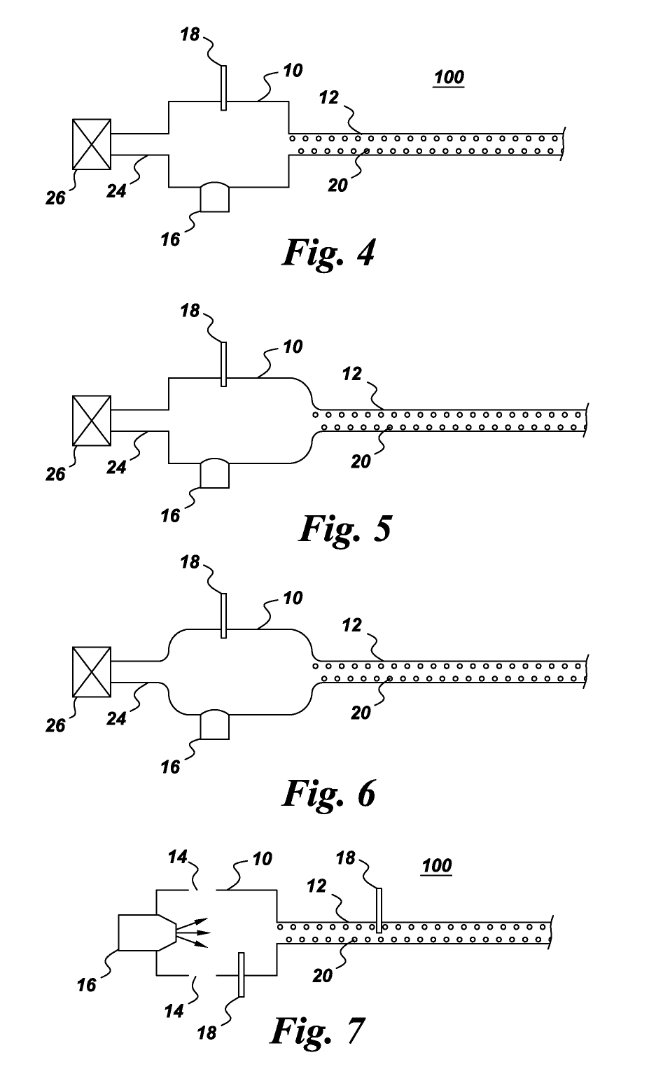

FIGS. 1 through 7 depict cross-sectional side views of a pulse detonation combustor chamber for a pulse detonation combustor according to various exemplary embodiments of the present invention. The pulse detonation combustor chamber 100 includes an ignition chamber 10 and a detonation chamber 12. The ignition chamber 10 and the detonation chamber 12 can be discrete chambers or formed as a contiguous chamber. In FIGS. 1-3, an oxidizer, e.g., air, is supplied to the ignition chamber 10 via inlet 14, while in FIGS. 4-7 the oxidizer is supplied via inlet passage 24. A fuel injector 16 is provided to supply fuel into the ignition chamber 10. The fuel injector can be arranged in various locations of the ignition chamber such as co-axial to the flow, perpendicular to the flow, at a tangential angle to the flow (to induce swirl), or at an angle in conjunction with a suitably shaped wall to help promote mixing. Any known mechanism for fuel injection can be used such as air-blast atomization, pressure-atomization, etc. The fuel and oxidizer mixture in the ignition chamber 10 is ignited by an ignition source 18, such as a spark plug, for example. Any suitable ignition source can be used. The location of the ignition source 18 can be arranged based upon the optimum ignition location for fuel-oxidizer mixing. In the exemplary embodiment, the ignition source 18 is placed downstream of the fuel injection. This arrangement allows time for the fuel to mix with the oxidizer and evaporate a bit. Overall, the ignition source 18 can be placed between the point of fuel injection and the beginning of any obstacles that may be arranged in the detonation chamber. Although a single ignition source 18 is shown in the exemplary embodiments, multiple ignition sources could also be used.

In the embodiments shown, the detonation chamber 12 includes an obstacle field or center body 20 to promote turbulence within the detonation chamber 12. The center body 20 is often referred to as deflagration to detonation transition (DDT) geometry. DDT geometry enhances the deflagration to detonation transition process by increasing turbulence in the detonation chamber 12. There are a variety of DDT geometries. The overall length and diameter of the center body 20 is determined based on operational parameters and characteristics to optimize performance. It is to be noted that the invention is not limited to the use of the center body 20 or DDT geometry.

In each of the exemplary embodiments shown in FIGS. 1-7, the ignition chamber 10 is larger than the detonation chamber 12. More specifically, the cross-sectional area of the ignition chamber 10 is larger than the cross-sectional area of the detonation chamber 12. For example, the volume of the detonation chamber 12 can be two times that of the ignition chamber 10. The ratio can be set to optimize the performance based upon the application. The cross-sectional area of the ignition chamber 10 with respect to that of the detonation chamber 12 can be selected to control the flow resistance and/or the temperature/pressure profile exiting the ignition chamber 10.

The enlarged ignition chamber 10 slows the oxidizer flow to promote fuel-oxidizer mixing, flame kernel growth and serves to prevent liquid fuel from wetting the walls of the ignition chamber 10. More particularly, by injecting fuel and oxidizer in the enlarged ignition chamber 10, the mixture velocity is slow at the point of ignition. This allows the flame kernel plenty of time to grow, even in relatively high bulk velocities. The mixture velocity then increases as the mixture transitions to the smaller detonation chamber 12. This transition increases turbulent mixing and promotes DDT. Cross-sectional area variations in the ignition chamber 10 and the detonation chamber 12 allow for control of the bulk flow velocity. This enhances liquid fuel injection, fuel-air mixing, initial flame kernel growth, DDT turbulence, and minimizes loads on the upstream components in the assembly.

The enlarged ignition chamber 10 allows for larger fuel spray without wetting the walls of the chamber. In addition, the enlarged ignition chamber 10 increases the residence time of the fuel-air mixture in the ignition chamber 10, which results in greater evaporation of the fuel and enables stable flame kernel growth. The enlarged ignition chamber 10 also reduces pressure drop and aerodynamic flow losses.

By transitioning from a large ignition chamber 10 to a smaller detonation chamber 14, the run-up distance and time are reduced and the overall pulse detonation combustor chamber length is reduced. This allows for the possibility of more practical applications of pulse detonation combustors, such as use in hybrid turbine engines. Other arrangements require a combustor length to diameter ratio (L/D) up to as much as 30 to transition to detonation, while the embodiments disclosed herein require L/D ratios of 20 or less, for example.

Reduced run-up length results in reduced run-up time. Reduced run-up time enables the combustor to operate at higher frequencies. Higher frequency will generate more pressure rise and increase the usable output of the PDE device.

Turning now to FIG. 1, an exemplary embodiment of the present invention is shown. In this embodiment, the ignition chamber 10 steps-down to the smaller detonation chamber 12. Fuel is injected co-axially from fuel injector 16. The co-axial injection of fuel reduces wall wetting and allows for a wider spray angle of fuel. Oxidizer is supplied to the ignition chamber 10 downstream of the fuel injection via opposing inlets 14. The detonation chamber 12 includes DDT geometry such as Schelkin spiral geometry, for example. Any suitable DDT geometry can be used to increase turbulence. Alternatively, the detonation chamber 12 can be arranged without DDT geometry. In addition, the fuel-oxidizer ratio can be supplied so that there is a slightly fuel-rich mixture in the ignition chamber 10 to improve the DDT process. This can be accomplished by controlling the flow of fuel and oxidizer into the ignition chamber 10.

The ignition source 18 in this embodiment is arranged downstream from the fuel and oxidizer inlets. As previously discussed, although a single ignition source is shown, the combustor can include multiple ignition sources including ignition sources in the detonation chamber 12. Referring to FIG. 2, the pulse detonation combustor chamber 100 includes the elements shown in FIG. 1, with the further inclusion of a flow mixing element 22. The flow mixing element 22 is arranged near the air inlet 14 to create a uniformly mixed flow of oxidizer and fuel into the ignition chamber 10. The flow mixing element 22 can be a perforated plate or a geometry to induce swirl or other turbulence for example. Any suitable flow mixing element can be used to promote the uniform flow of air into the ignition chamber 10.

FIG. 3 illustrates another exemplary embodiment of the pulse detonation combustor chamber 100. In this embodiment, the combustor chamber includes all of the elements shown in FIG. 1, except that the enlarged ignition chamber 10 tapers to converge with the smaller detonation chamber 12. The taper results in lower pressure drop through the transition from large diameter to small diameter. In addition, the taper can result in a smoother flow for mixing.

Referring to FIG. 4, another exemplary embodiment of the present invention is shown. In this embodiment, the inlets 14 of the pulse detonation combustor chamber 100 are replaced with an inlet passage 24. The inlet passage 24 receives oxidizer from an oxidizer source through a valve 26 and supplies it to the ignition chamber 10. The cross-sectional area of the inlet passage 24 is smaller than that of the ignition chamber 10. The smaller cross-sectional area of the inlet passage 24 relative to the ignition chamber 10 minimizes valve inertial loads and pressure forces. However, the invention is not limited to this arrangement, and the cross-sectional area of the inlet passage can be selected based upon the application. In this embodiment, fuel is supplied from the fuel injector 16, which is arranged perpendicular to the inlet passage 24 and to the ignition chamber 10. The fuel injector 16 can also be arranged in the transition corner where the inlet passage 24 meets the ignition chamber 10.

FIG. 5 shows another exemplary embodiment of the pulse detonation combustor chamber 100 where the ignition chamber 10 tapers to converge with the detonation chamber 12. The taper reduces pressure drop or aerodynamic losses. In FIG. 6, both transition corners are tapered. More specifically, the inlet passage 24 tapers to diverge with the ignition chamber 10 while the ignition chamber tapers to converge with the detonation chamber 12. The arrangement of the ignition source 18 and fuel injector 16 are similar to those in FIGS. 4-5. Each of the embodiments shown in FIGS. 3-6 could also include a flow mixing element to promote uniform flow into the ignition chamber 10.

Referring to FIG. 7, the pulse detonation combustor chamber according to this exemplary embodiment includes multiple ignition sources 18, including one arranged within the detonation chamber 12. As previously noted, any number and location of ignition sources may be used to achieve optimal performance.

The pulse detonation combustor chamber according to the exemplary embodiments disclosed herein is configured to reduce the run-up length, and consequently, run-up time. This is achieved by including an enlarged ignition chamber with respect to the detonation chamber. This arrangement allows for the reduced length of the pulse detonation combustor chamber, and consequently, reduced length of the pulse detonation combustor. More specifically, the enlarged ignition chamber provides for slow mixture velocity at the time of ignition, which promotes stable flame kernel growth. The mixture velocity then increases as the mixture transitions to the smaller detonation chamber. This transition increases turbulent mixing and promotes DDT. Cross-sectional area variations in the ignition chamber and the detonation chamber allow for control of the bulk flow velocity. This enhances liquid fuel injection, fuel-air mixing, initial flame kernel growth, DDT turbulence, which results in reduced run-up time.

The reduced length of the combustor chamber provides for more practical applications of combustors including these combustor chambers in turbine engines, for example. In addition, the reduced run-up length enables operation at higher frequencies to increase the pressure rise resulting in more output to the device and provides a higher efficiency gain when replacing a constant pressure combustor with a PDC.

It is noted that the above embodiments have been shown with respect to a single pulse detonation combustor chamber. However, the concept of the present invention is not limited to single pulse detonation combustor chamber embodiments.

It is noted that although embodiments of the present invention have been discussed above specifically with respect to aircraft and power generation turbine engine applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. A pulse detonation combustor chamber for a pulse detonation combustor, comprising:
an ignition chamber having a first cross-sectional area and arranged to generate a flame upon ignition of a flammable mixture contained in the ignition chamber;
a detonation chamber coupled to the ignition chamber and having a second cross-sectional area that is smaller than the first cross-sectional area of the ignition chamber, wherein the flame propagates into the detonation chamber and detonates within the detonation chamber.

2. The pulse detonation combustor chamber of claim 1, further comprising a fuel injector to supply fuel into the ignition chamber.

3. The pulse detonation combustor chamber of claim 2, wherein the fuel injector is arranged to allow axial injection of the fuel into the ignition chamber.

4. The pulse detonation combustor of claim 1, further comprising an ignition device to ignite the flammable mixture contained in the ignition chamber.

5. The pulse detonation combustor of claim 1, wherein the ignition chamber comprises an opening to allow oxidizer to flow into the ignition chamber.

6. The pulse detonation combustor chamber of claim 5, further comprising a fuel injector to supply fuel into the ignition chamber, wherein the opening is arranged upstream of the fuel injector.

7. The pulse detonation combustor chamber of claim 1, wherein the transition between the ignition chamber and the detonation chamber is aerodynamically shaped to minimize pressure drop.

8. The pulse detonation combustor chamber of claim 1, further comprising an inlet passage coupled to the ignition chamber and having a third cross-sectional area that is smaller than the first cross-sectional area of the ignition chamber, wherein the inlet passage is arranged to allow oxidizer to flow into the ignition chamber.

9. The pulse detonation combustor chamber of claim 8, wherein the transition between the ignition chamber and inlet passage is aerodynamically shaped to reduce pressure drop, and wherein the inlet passage is arranged opposite the detonation chamber.

10. The pulse detonation combustor chamber of claim 8, wherein the transition between the ignition chamber and the detonation chamber is aerodynamically shaped to minimize pressure drop.

11. The pulse detonation combustor chamber of claim 1, wherein the detonation chamber comprises an obstacle to promote detonation.

12. The pulse detonation combustor chamber of claim 11, wherein the flammable mixture comprises an oxidizer and fuel, and wherein the ignition chamber comprises a structure to promote uniform mixture of the oxidizer and the fuel into the ignition chamber.

13. The pulse detonation combustor chamber of claim 12, wherein a fuel-oxidizer ratio is fuel rich in the ignition chamber.

14. The pulse detonation combustor chamber of claim 1, wherein the ignition chamber and the detonation chamber are cylinders.

15. The pulse detonation combustor chamber of claim 1, wherein the detonation chamber is contiguous with the ignition chamber.

16. The pulse detonation combustor chamber of claim 1, wherein the ignition chamber comprises a structure to promote uniform mixture of oxidizer and fuel into the ignition chamber.

17. The pulse detonation combustor chamber of claim 1, wherein the first cross-sectional area of the ignition chamber and the second cross-sectional area of the detonation chamber are arranged to achieve a predetermined flow resistance.

18. A pulse detonation combustor, comprising:
at least one pulse detonation combustor chamber comprising a first portion having a first cross-sectional area and a second portion having a second cross-sectional area that is less than the first cross-sectional area of the first portion, wherein the first portion contains a flammable mixture of fuel and oxidizer that generates a flame upon ignition; and
an inlet to allow at least one of the fuel and the oxidizer to flow into the first portion of the pulse detonation combustor chamber.

19. The pulse detonation combustor according to claim 18, further comprising an ignition device to ignite the fuel and the oxidizer contained in the first portion of the pulse detonation tube.

20. The pulse detonation combustor according to claim 18, wherein the transition between the first portion and the second portion of the pulse detonation combustor chamber is aerodynamically shaped to minimize pressure drop.

21. The pulse detonation combustor according to claim 18, further comprising an obstacle in the second portion of the pulse detonation combustor chamber to promote detonation of the flame propagating from the first portion into the second portion of the pulse detonation combustor chamber.

22. The pulse detonation combustor according to claim 21, wherein the ignition chamber comprises a structure to promote uniform mixture of the oxidizer and the fuel into the ignition chamber.

23. The pulse detonation combustor according to claim 18, further comprising a fuel injector to supply fuel into the first portion of the pulse detonation combustor chamber.

24. The pulse detonation combustor of claim 23, wherein the fuel is liquid fuel.

25. The pulse detonation combustor of claim 23, wherein the fuel injector is arranged downstream from the inlet.

26. The pulse detonation combustor of claim 18, further comprising a structure arranged in the first portion of the pulse detonation combustor chamber to promote uniform mixture of the oxidizer and the fuel.

27. The pulse detonation combustor of claim 18, wherein the pulse detonation combustor chamber is a cylinder.

28. The pulse detonation combustor of claim 18, wherein the first portion and the second portion are contiguous.

29. The pulse detonation combustor of claim 18, further comprising an inlet passage coupled to inlet of the ignition chamber and having a third cross-sectional area that is smaller than the first cross-sectional area of the ignition chamber, wherein the inlet passage is arranged to allow oxidizer to flow into the ignition chamber via the inlet.

30. The pulse detonation combustor chamber of claim 29, wherein the transition between the ignition chamber and inlet passage is aerodynamically shaped to reduce pressure drop, and wherein the inlet passage is arranged opposite the detonation chamber.

31. The pulse detonation combustor chamber of claim 29, wherein the transition between the ignition chamber and the detonation chamber is aerodynamically shaped to minimize pressure drop.

32. An engine, comprising:
a pulse detonation combustor, comprising:
at least one pulse detonation combustor chamber comprising a first portion having a first cross-sectional area and a second portion having a second cross-sectional area that is less than the first cross-sectional area of the first portion, wherein the first portion contains a flammable mixture of fuel and oxidizer that generates a flame upon ignition; and
an inlet to allow at least one of the fuel and the oxidizer to flow into the first portion of the pulse detonation combustor chamber.

33. The engine of claim 32, further comprising an ignition device to ignite the fuel and the oxidizer contained in the first portion of the pulse detonation combustor chamber.

34. The engine of claim 32, wherein the transition between the first portion and the second portion of the pulse detonation combustor chamber is aerodynamically shaped to minimize pressure drop.

35. The engine of claim 32, further comprising an obstacle in the second portion of the pulse detonation combustor chamber to promote detonation of the flame propagating from the first portion into the second portion of the pulse detonation combustor chamber.

36. The engine of claim 32, further comprising a fuel injector to supply fuel into the first portion of the pulse detonation combustor chamber.

37. The engine of claim 36, wherein the fuel is liquid fuel.

38. The engine of claim 36, wherein the fuel injector is arranged downstream from the inlet.

39. The engine of claim 32, further comprising a structure arranged in the first portion of the pulse detonation combustor chamber to promote uniform mixture of the oxidizer and the fuel.

40. The engine of claim 32, wherein the pulse detonation combustor chamber is a cylinder.

41. The pulse detonation combustor of claim 32, further comprising an inlet passage coupled to inlet of the ignition chamber and having a third cross-sectional area that is smaller than the first cross-sectional area of the ignition chamber, wherein the inlet passage is arranged to allow oxidizer to flow into the ignition chamber via the inlet.

42. The pulse detonation combustor chamber of claim 41, wherein the transition between the ignition chamber and inlet passage is aerodynamically shaped to reduce pressure drop, and wherein the inlet passage is arranged opposite the detonation chamber.

43. The pulse detonation combustor chamber of claim 41, wherein the transition between the ignition chamber and the detonation chamber is aerodynamically shaped to minimize pressure drop.
